(19) United States
(12) Patent Application Publication
(10) Pub. No.: US 2021/0192322 A1
(43) Pub. Date: Jun. 24, 2021

(54) Method For Determining A Confidence Level Of Inference Data Produced By Artificial Neural Network

(71) Applicant: ZEROONE AI INC., Seoul (KR)

(72) Inventors: JUNHO SONG, Gyeonggi-do (KR); SEUNGWOO LEE, Gyeonggi-do (KR); YOUNG JUN CHAI, Seoul (KR); WOO JIN LEE, Seoul (KR)

(73) Assignee: ZEROONE AI INC., Seoul (KR)

(21) Appl. No.: 16/984,485

(22) Filed: Aug. 4, 2020

(30) Foreign Application Priority Data
Dec. 23, 2019 (KR) 10-2019-0172651

(51) Int. Cl. G06N 3/04; G06N 3/08

(52) U.S. Cl. CPC G06N 3/0472; G06N 3/08

(57) ABSTRACT

According to an exemplary embodiment of the present disclosure, provided is a non-transitory computer readable medium storing a computer program. The computer program comprising instructions for causing one or more processors to perform the following steps and the steps may include: obtaining a first distribution expression, wherein the first distribution expression is an expression of a distribution in a latent space for at least one class included in a first class set related to a first data set; obtaining a second distribution expression, wherein the second distribution expression is an expression of a distribution in a latent space for each of the at least one class included in a second class set related to a second data set; computing a similarity between the first distribution expression and the second distribution expression; computing a relation degree between an interpretation degree and an inference result for the second data set, based on an interpretation data about an artificial neural network; and computing a confidence level using the similarity and the relation degree.

### CROSS-REFERENCE TO RELATED APPLICATIONS

This application claims priority to and the benefit of Korean Patent Application No. 10-2019-0172651 filed in the Korean Intellectual Property Office on Dec. 23, 2019, the entire contents of which are incorporated herein by reference.

### TECHNICAL FIELD

The present disclosure relates to a method for processing information using a computing device, and particularly, to artificial neural network related technology.

### BACKGROUND ART

With the recent development of artificial neural network technology, especially, deep learning technology, inference data by an artificial neural network is used in various fields. However, artificial neural network technology has a problem that it is difficult for humans to understand how data is processed inside a neural network, and is sometimes called a black box.

A feature of the artificial neural network technology may be a problem in fields that require a basis for judgment, such as medical, financial, and military fields.

To solve the problem, technology for securing analytical power for an artificial neural network model has emerged. However, there is a problem in that the analysis techniques for such an artificial neural network model do not quantitatively provide a user with a confidence level for a result inferred by the artificial neural network. In this case, the inference result of the artificial neural network is interpreted by human qualitative judgment, and the interpretation will be still poor as the basis for the inference result.

Accordingly, there is a need for a technique in the art that provides the quantitative confidence level for the inference result derived by artificial nerves.

### SUMMARY OF THE INVENTION

The present disclosure has been made to provide a quantified confidence level value for inference data so that a user determines whether to confide in an inference result of an artificial neural network.

However, technical objects of the present disclosure are not restricted to the technical object mentioned above. Unmentioned technical objects will be appreciated by those skilled in the art by referencing the following description.

An exemplary embodiment of the present disclosure provides a non-transitory computer readable medium storing a computer program. The computer program comprising instructions for causing one or more processors to perform the following steps and the steps may include: obtaining a first distribution expression, wherein the first distribution expression is an expression of a distribution in a latent space for at least one class included in a first class set related to a first data set; obtaining a second distribution expression, wherein the second distribution expression is an expression of a distribution in a latent space for each of the at least one class included in a second class set related to a second data set; computing a similarity between the first distribution expression and the second distribution expression; computing a relation degree between an interpretation degree and an inference result for the second data set, based on an interpretation data about an artificial neural network; and computing a confidence level using the similarity and the relation degree.

The first data set may be a training data set and the second data set may be a validation data set.

The obtaining a second distribution expression may include feeding the second data set to the artificial neural network repeatedly until the second distribution expression meets a pre-set criteria.

The computing a similarity between the first distribution expression and the second distribution expression may include computing a similarity based on distance data between the first distribution expression and the second distribution expression, wherein the distance data is computed based on the class related to the first data and the second data.

The computing a similarity based on distance data between the first distribution expression and the second distribution expression may include: identifying a distribution expression corresponding to the first class in the first distribution expression; identifying a distribution expression corresponding to the first class in the second distribution expression; computing the distance data between two said distribution expression corresponding to the first class; and computing the similarity based on the distance data.

The computing a similarity between the first distribution expression and the second distribution expression may include computing a similarity based on each representative expression of the first distribution expression and the second distribution expression.

The computing a similarity based on each representative expression of the first distribution expression and the second distribution expression may include: computing a first representative expression representing whole data included in the first distribution expression; computing a second representative expression represents whole data included in the second distribution expression; computing a distance data between the first representative expression and the second representative expression; and computing the similarity based on the distance data.

The confidence level may be computed using at least one among a distribution or variance of the similarity and the relation degree, a relationship between the first data set and the second data set, or the interpretation degree of the artificial neural network.

The steps may further include: recognizing error information based on at least one of the similarity, the relation degree or the interpretation degree; and performing the confidence level update based on the error information.

Technical solving means which can be obtained in the present disclosure are not limited to the aforementioned solving means and other unmentioned solving means will be clearly understood by those skilled in the art from the following description.

According to exemplary embodiments of the present disclosure, a quantitative confidence level value for judgment of an artificial neural network can be provided to a user by a method according to the present disclosure.

The effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for description, multiple specific detailed matters are presented to provide a general understanding of one or more aspects. However, it will be apparent that the aspect(s) can be executed without the detailed matters.

FIG. 1 is a block diagram illustrating a configuration of an exemplary computing device performing a method according to the present disclosure.

FIG. 2 illustrates an example of a distribution expression which a processor obtains to compute a similarity according to the present disclosure.

FIG. 3 illustrates an example of data for computing a relation degree between an interpretation degree and an inference result according to the present disclosure.

FIG. 4 illustrates data for computing a relation degree between an interpretation degree and an inference result according to the present disclosure.

FIG. 5 is a flowchart illustrating an example in which a processor computes a confidence level for an inference result according to the present disclosure.

FIG. 6 is a flowchart illustrating an example in which a processor computes a similarity according to the present disclosure.

FIG. 7 is a flowchart illustrating an example in which a processor computes a similarity according to the present disclosure.

FIG. 8 is a flowchart illustrating an example in which a processor performs update of a confidence level according to the present disclosure.

FIG. 9 illustrates a simple and general schematic view of an exemplary computing environment in which some exemplary embodiments of the present disclosure may be implemented.

### DETAILED DESCRIPTION

Various embodiments and/or aspects will be now disclosed with reference to drawings. In the following description, for description, multiple detailed matters will be disclosed to help a comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of the various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the exemplary embodiment disclosed in this specification and the technical spirit disclosed by this specification is not limited by the accompanying drawings.

It is also to be understood that the terminology used herein is to describe embodiments only and is not intended to limit the present disclosure. In this specification, singular forms include even plural forms unless the context indicates otherwise. It is to be understood that the terms “comprise” and/or “comprising” used in the specification does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the cases where X uses A, the case where X uses B, or the case where X uses both A and B. Further, it should be understood that the term “and/or” used in this specification designates and includes all available combinations of one or more items among enumerated related items.

The terms “information” and “data” used in the specification may also be often used to be exchanged with each other.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The objects and effects of the present disclosure and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to the exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

Throughout this specification, an artificial neural network, a network function, and a neural network may be used as the same meaning. The artificial neural network may be generally constituted by an aggregate of calculation units which are mutually connected, which may be called “node”. The “nodes” may also be called “neurons”. The artificial neural network is configured to include one or more nodes. The nodes (alternatively, neurons) constituting the artificial neural networks may be connected by one or more “links”.

In the artificial neural network, one or more nodes connected through the link may relatively form the relationship between an input node and an output node. Concepts of the input node and the output node are relative and a predetermined node that has the output node relationship with respect to one node may have the input node relationship in the relationship with another node and vice versa. As described above, the relationship of the output node to the input node may be generated based on the link. One or more output nodes may be connected to one input node through the link and vice versa.

In the relationship of the input node and the output node connected through one link, the value of the output node may be determined based on data input in the input node. Here, a node connecting the input node and the output node may have a weight. The weight may be variable and the weight is variable by a user or an algorithm for the artificial neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the artificial neural network, one or more nodes are connected through one or more links to form the input node and output node relationships in the artificial neural network. A characteristic of the artificial neural network may be determined according to the number of nodes, the number of links, correlations between the nodes and the links, and values of the weights granted to the respective links in the artificial neural network. For example, when the same number of nodes and links exist and there are two artificial neural networks in which the weight values of the links are different from each other, it may be recognized that two artificial neural networks are different from each other.

The artificial neural network may be configured to include one or more nodes. Some of the nodes constituting the artificial neural network may constitute one layer based on distances from an initial input node. For example, an aggregation of nodes of which the distance from the initial input node is n may constitute an n layer. The distance from the initial input node may be defined by the minimum number of links through which should pass for reaching the corresponding node from the initial input node. However, the definition of the layer is predetermined for description and the order of the layer in the artificial neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the artificial neural network. Alternatively, in the artificial neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the artificial neural network. Further, a hidden node may mean not the initial input node and the final output node but the nodes constituting the artificial neural network. In the artificial neural network according to an exemplary embodiment of the present disclosure, the number of nodes of the input layer may be larger than the number of nodes of the hidden layer close to the output layer, and the neural network may be an artificial neural network of a type in which the number of nodes decreases as the layer progresses from the input layer to the hidden layer.

A deep neural network (DNN) may refer to an artificial neural network that includes a plurality of hidden layers in addition to the input and output layers. When the deep neural network is used, the latent structures of data may be determined. In other words, latent structures (e.g., what objects are in the picture, what the content and feelings of the text are, what the content and feelings of the voice are) of photos, text, video, voice, and music may be determined. The deep neural network may include a convolutional neural network (CNN), a recurrent neural network (RNN), a restricted Boltzmann machine (RBM), a deep belief network (DBN), a Q network, a U network, a Siam network, and the like.

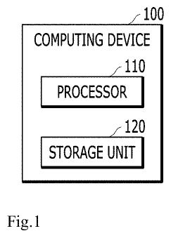

FIG. 1 is a block diagram illustrating a configuration of an exemplary computing device performing a method according to the present disclosure.

The computing device 100 may include a processor 110 and a memory 120. The processor 110 may be constituted by one or more cores and may include processors 110 for quantifying a confidence level for an inference result of an artificial neural network, which includes a central processing unit (CPU), a general purpose graphics processing unit (GPGPU), a tensor processing unit (TPU), and the like of the computing device 100. The processor 110 may read a computer program stored in the memory 120 to perform a method for computing a confidence level for an inference result of an artificial neural network according to an exemplary embodiment of the present disclosure. According to an exemplary embodiment of the present disclosure, the processor 110 may perform a calculation for learning the artificial neural network. The processor 110 may perform calculations for learning the artificial neural network, which include processing of input data for learning in deep learning (DN), extracting a feature in the input data, calculating an error, updating a weight of the artificial neural network using backpropagation, and the like.

At least one of the CPU, GPGPU, and TPU of the processor 110 may generate a training data set and process learning of the artificial neural network. Further, in an exemplary embodiment of the present disclosure, the inference result may be generated and the confidence level for the inference result may be provided by using the artificial neural network learned by using the processor 110 of the computing device 100. Further, the computer program executed in the computing device 100 according to an exemplary embodiment of the present disclosure may be a CPU, GPGPU, or TPU executable program.

The memory 120 may store a computer program for performing a method for determining the confidence level for the inference result according to an exemplary embodiment of the present disclosure and the stored computer program may be read and driven by the processor 110.

The memory 120 according to exemplary embodiments of the present disclosure may store a program for an operation of the processor 110 therein and temporarily or persistently store input/output data (e.g., service entrance information, user information, alternative service access information, etc.). The memory 120 may store data regarding the display and the sound. The memory 120 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

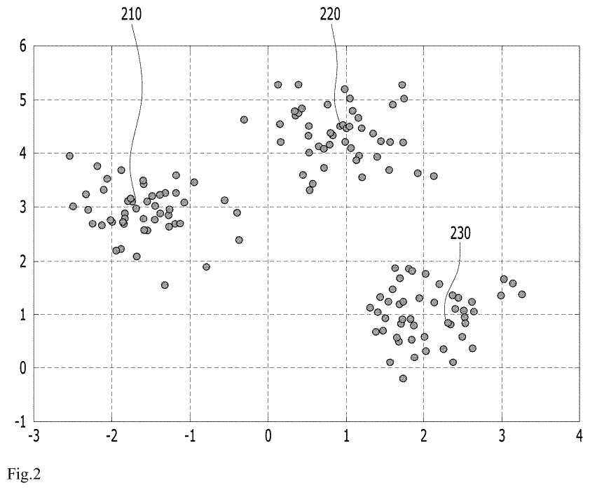

FIG. 2 illustrates an example of a distribution expression which a processor obtains to compute a similarity according to the present disclosure.

In the present disclosure, a latent space may mean a space that may well express data included in a data set.

Data included in a predetermined data set may be expressed in the latent space. The data expressed in the latent space may be data for supervised learning, data for unsupervised learning, or data for reinforcement learning.

The data expressed in the latent space may be classified for each class. Here, the class may mean a classification result or label for specific data. Thus, a distribution in the latent space of data having the same class may be obtained.

The data expressed in the latent space included in the data set may correspond to one or more classes and respective classes may be expressed by a specific distribution in the latent space. Referring to FIG. 2, a first class 210, a second class 220, and a third class 230 may be expressed by specific distributions, respectively.

When the data expressed in the latent space is the data for supervised learning, the data may be classified for each class.

In this case, the distribution expression may be a set of one or more distribution parameters of the data in the same class.

As an example, the distribution parameter may a vector representing an average of coordinates of data corresponding to the first class in the latent space. As another example, the distribution parameter may express the distribution of the data corresponding to the first class in the latent space as a probability distribution.

When the data expressed in the latent space is the data for unsupervised learning, the data may be clustered by a clustering technique, for example. In this case, the data expressed in the latent space may be data representing a distribution of data included in the same cluster.

As an example, the distribution parameter may be expressed as a vector representing an average of coordinates of data included in a first cluster in the latent space, a diameter in the cluster, a variance in the cluster, etc. As yet another example, the distribution parameter may be a parameter when the distribution of the data included in the first cluster in the latent space is expressed as the probability distribution.

The contents are just examples of the distribution parameter and the distribution expression, and as a result, the contents are not limited thereto.

In the present disclosure, a first distribution expression may mean a distribution expression for a first data set. Further, in the present disclosure, a second distribution expression may mean a distribution expression for a second data set.

In the present disclosure, distance data may be data expressing a distance between distributions of two different classes or both cluster data.

As an example, when the distribution expression is an average value of coordinates of data included in the cluster in the latent space, distance data between two different clusters may be expressed as a Euclidean distance.

As another example, when the distribution expression is the probability distribution of the data in the latent space, the distance data between two different clusters may be computed by using Kullback-Leibler divergence.

This is just an example of a method for computing the distance data between two different clusters and the method for computing the distance data is not limited thereto.

A similarity may be a value representing a statistical origin relationship of data included in two clusters, based on the computed distance data.

For example, when the distance data is expressed as the Euclidean distance, the similarity may be expressed as an inverse number of the distance data. However, the computation method of the similarity may vary depending on a format of the distance data.

This is just an example of a method for expressing the similarity between two classes and the method for computing the similarity is not limited thereto.

By computing the similarity as described above, a statistical similarity between different data clusters may be determined. A similarity between a data cluster corresponding to the first cluster in the first data set and the data cluster corresponding to the first class in the second data set may be determined by the computation of the similarity (it is assumed that a plurality of data included in the first data set and a plurality of data included in the second data set are expressed in the same latent space).

The similarity may be used for determining (1) a similarity of a statistical characteristic between two data clusters or (2) whether the artificial neural network is appropriately trained.

A case where the similarity between the first class of the first data set and the first class of the second data set is low may mean (1) that at least one of a dog photo cluster of the first data set or the dog photo cluster of the second data set is biased or (2) that the artificial neural network is in an underfitting or overfitting state.

On the contrary, a case where the similarity between the first class of the first data set and the first class of the second data set is high may mean (1) that statistical characteristics of two data clusters are similar or (2) that the artificial neural network is appropriately trained.

This is just an example for the meaning of the similarity and a result of the determination may vary according to whether classification results of the data are previously known, whether the statistical characteristics of the data are previously known, etc. Accordingly, the meaning of the similarity should not be limited to the above description.

Accordingly, the processor 110 may recognize whether the artificial neural network is appropriately trained based on the computed similarity. Based thereon, the processor 110 may decide whether to stop a training process of the artificial neural network or whether to newly train the artificial neural network. Therefore, an unnecessary training process is omitted to save cost and time required for training the neural network.

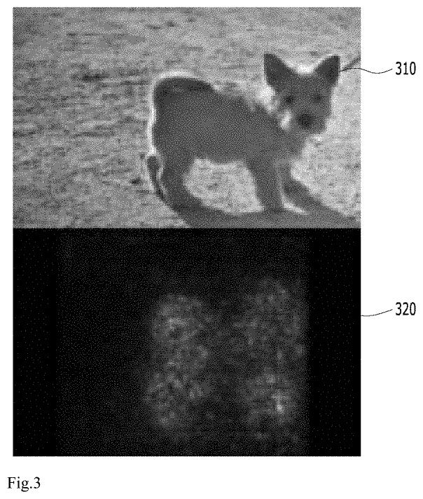

FIG. 3 illustrates an example of data for computing a relation degree between an interpretation degree and an inference result according to the present disclosure.

In the present disclosure, interpretation data may mean a feature(s) which is a basis for generating the inference result for predetermined data or an index obtained by quantifying the features.

As an example, in a photo of a dog 310 of FIG. 3, the processor 110 may generate interpretation data for the artificial neural network capable of classifying the dog from an image by using a saliency map.

In this case, for example, the interpretation data may be a region defined by the number of saliency points (the number of pixels) or a region ratio of the corresponding region to an entire image. Accordingly, in FIG. 3, the number of pixels or area of saliency points included in a saliency map 320 for the dog 310 may be the interpretation data.

Here, the saliency map may be defined as data generated for the purpose of expressing a major part of the image that derives a prediction result in a context of a description of the prediction result of a convolutional neural network.

However, since the method using the saliency map is just an example for generating the interpretation data, the method for generating the interpretation data should not be limited thereto.

In the present disclosure, an interpretation degree may be defined as a value obtained by quantifying how the interpretation data satisfies a pre-defined interpretation criterion.

For example, in the dog photo of FIG. 3, a region inside a boundary line for distinguishing a background from the “dog 310” may be a criterion for identifying that an object included in the illustrated photo is the dog. Accordingly, in this case, the “pre-defined interpretation criterion” may be defined as a region ratio of the region inside the boundary line to the entire image.

In this case, the interpretation degree may be a value obtained by dividing the region ratio of the saliency map by the region ratio inside the boundary line. Therefore, as the region ratio detected in the saliency map for specific image data is lower than the region ratio inside the boundary line, it may be determined that a current artificial neural network model is not able to interpret the image data well, and as a result, a low interpretation degree may be given.

The interpretation degree may be defined for one predetermined data or a specific entire data class (e.g., average of the interpretation degree).

Since the contents are just an example for generating the interpretation degree, the method for generating the interpretation degree should not be limited thereto.

In the present disclosure, a relation degree may be defined as a value obtained by quantifying the relationship between the interpretation data and the interpretation degree, and the inference result.

For example, when the relationship between the interpretation degree and the inference result (probability) is expressed on a 2-dimensional plane, a correlation between the interpretation degree and the inference result may be computed. When there is a positive correlation between the interpretation degree and the inference result, it may be determined that the artificial neural network model is appropriately trained.

The relation degree may be generated based on a confusion matrix. Based on whether the interpretation degree exceeds a pre-set criterion, when the interpretation degree exceeds the pre-set criterion, if a prediction result is accurate, True Positive is set and if the prediction result is inaccurate, False Positive is set and when the interpretation degree does not exceed the pre-set criterion, if the prediction result is accurate, False Negative is set and if the prediction result is inaccurate, True Negative is set and then precision, sensitivity and accuracy are computed to decide one thereof as the relation degree.

This is just an example of the method for computing the relation degree based on the relationship between the interpretation degree and the inference result.

According to the relation degree, it may be determined whether the inference result currently generated by the artificial neural network is reasonable. For example, in the photo of FIG. 3, the artificial neural network may generate the inference result based on another region other than an internal region of the boundary of the dog. In this case, in principle, the artificial neural network should not classify the object of the photo of FIG. 3 as the dog. Nevertheless, if the artificial neural network classifies the object in the photo of FIG. 3 as the dog, this may mean that the artificial neural network is overfitted with data similar to FIG. 3.

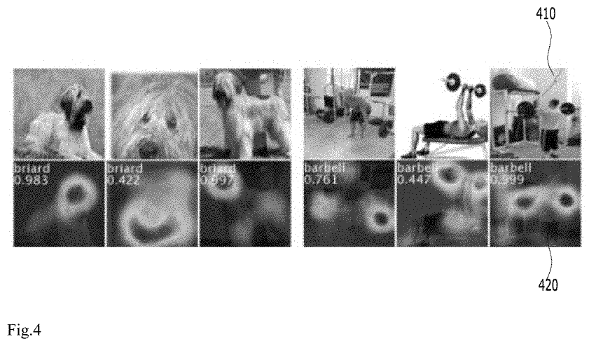

FIG. 4 illustrates data for computing a relation degree between an interpretation degree and an inference result according to the present disclosure.

In the present disclosure, a class activation map, as a method for finding by which part of the image and for which input image the prediction result of the convolutional neural network is caused, may be defined as a method for confirming an ‘average’ activation result of all feature maps for a specific prediction class by visualizing only a result of calculating a weighted sum of corresponding feature maps by using a weight just before an output layer.

In the class activation map of FIG. 4, the interpretation data may be defined as an overall activation degree (weighted sum) of all feature maps.

Referring to FIG. 4, a class activation map 420 for an original photo 410 may be seen. In the class activation map 420, an activation degree (weighted sum) of feature maps for a barbell is expressed.

If the feature maps are perfectly activated for the barbell, the class activation degree will be 1 (see reference numerals 410 and 420). Accordingly, in this case, the interpretation degree may be defined as an entire activation degree for specific data itself (i.e., may be the same case as the interpretation data).

Even in FIG. 4, when the relationship between the interpretation degree and the inference result (probability) is expressed on the 2-dimensional plane, the correlation between the interpretation degree and the inference result may be computed. When there is a positive correlation between the interpretation degree and the inference result, it may be determined that the artificial neural network model is appropriately trained.

The relation degree may be generated based on the confusion matrix. Based on whether the interpretation degree exceeds a pre-set criterion, when the interpretation degree exceeds the pre-set criterion, if a prediction result is accurate, True Positive is set and if the prediction result is inaccurate, False Positive is set and when the interpretation degree does not exceed the pre-set criterion, if the prediction result is accurate, False Negative is set and if the prediction result is inaccurate, True Negative is set and then precision, sensitivity, and accuracy are computed to decide one thereof as the relation degree.

This is just an example of the method for computing the relation degree based on the relationship between the interpretation degree and the inference result.

According to the relation degree, it may be determined whether the inference result currently generated by the artificial neural network is reasonable. For example, in the photo of FIG. 3, the artificial neural network may generate the inference result based on another region other than an internal region of the boundary of the dog. In this case, in principle, the artificial neural network should classify the object of the photo of FIG. 3 as the dog. Nevertheless, if the artificial neural network classifies the object in the photo of FIG. 3 as the dog, this may mean that the artificial neural network is overfitted with data similar to FIG. 3.

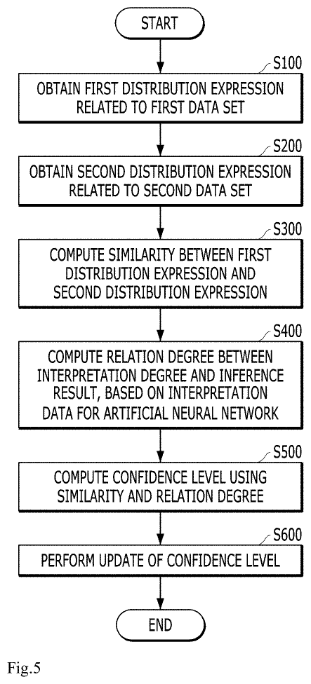

FIG. 5 is a flowchart illustrating an example in which a processor computes a confidence level for an inference result according to the present disclosure.

The processor 110 may obtain a first distribution expression related to a first data set (S100).

Data included in the predetermined data set may be expressed in the latent space. The data expressed in the latent space may be data for supervised learning, data for unsupervised learning, or data for reinforcement learning.

The processor 110 may obtain a second distribution expression related to a second data set (S200).

For example, when the first data set is a training data set, the second data set may be a validation data set, a test data set, or another training data set. In this case, according to the confidence level determination method according to the present disclosure, the determination may be made for the statistical similarity between two data sets or a training degree of the artificial neural network.

The processor 110 may repeatedly feed the second data set into the artificial neural network until the second distribution expression satisfies a pre-set criterion.

Even though the same data is fed into the artificial neural network, the same data may be expressed differently in the latent space according to the configuration of the artificial neural network. The processor 110 may feed second data into the artificial neural network until another expression for the same data is expressed in the latent space over a pre-set number of times. As a result, the statistical expression for the second data may be supported by a sufficient number of samples.

In this case, the pre-set number of times may be set based on, for example, central limit theorem (CLT), but this is just an example, and as a result, the scope should not be limited thereto.

The processor 110 may compute the similarity between the first distribution expression and the second distribution expression (S300).

A similarity may be a value representing a statistical origin relationship of data included in two clusters, based on the computed distance data.

For example, when the distance data is expressed as the Euclidean distance, the similarity may be expressed as an inverse number of the distance data. However, the computation method of the similarity may vary depending on a format of the distance data.

This is just an example of a method for expressing the similarity between two classes and the method for computing the similarity is not limited thereto.

By computing the similarity as described above, a statistical similarity between different data clusters may be determined. For example, a similarity between a data cluster corresponding to the first cluster in the first data set and the data cluster corresponding to the first class in the second data set may be determined by the computation of the similarity (it is assumed that a plurality of data included in the first data set and a plurality of data included in the second data set are expressed in the same latent space).

The similarity may be used for determining (1) a similarity of a statistical characteristic between two data clusters or (2) whether the artificial neural network is appropriately trained.

A case where the similarity between the first class of the first data set and the first class of the second data set is low may mean (1) that at least one of a dog photo cluster of the first data set or the dog photo cluster of the second data set is biased or (2) that the artificial neural network is in an underfitting or overfitting state.

On the contrary, a case where the similarity between the first class of the first data set and the first class of the second data set is high may mean (1) that statistical characteristics of two data clusters are similar or (2) that the artificial neural network is appropriately trained.

This is just an example for the meaning of the similarity and a result of the determination may vary according to whether classification results of the data are previously known, whether the statistical characteristics of the data are previously known, etc. Accordingly, the meaning of the similarity should not be limited to the above description.

Accordingly, the processor 110 may recognize whether the artificial neural network is appropriately trained based on the computed similarity. Based thereon, the processor 110 may decide whether to stop a training process of the artificial neural network or whether to newly train the artificial neural network. Therefore, an unnecessary training process is omitted to save cost and time required for training the neural network.

The processor 110 may compute the relation degree between the interpretation degree and the inference result based on the interpretation data for the artificial neural network (S400).

As described above in FIG. 3, in the present disclosure, interpretation data may mean a feature(s) which is a basis for generating the inference result for predetermined data or an index obtained by quantifying the features.

In the present disclosure, an interpretation degree may be defined as a value obtained by quantifying how the interpretation data satisfies a pre-defined interpretation criterion.

In the present disclosure, a relation degree may be defined as a value obtained by quantifying the relationship between the interpretation data and the interpretation degree, and the inference result.

For example, when the relationship between the interpretation degree and the inference result (probability) is expressed on a 2-dimensional plane, a correlation between the interpretation degree and the inference result may be computed. When there is the positive correlation between the interpretation degree and the inference result, it may be determined that the artificial neural network model is appropriately trained.

According to the relation degree, it may be determined whether the inference result currently generated by the artificial neural network is reasonable. For example, in the photo of FIG. 3, the artificial neural network may generate the inference result based on another region other than an internal region of the boundary of the dog. In this case, in principle, the artificial neural network should not classify the object of the photo of FIG. 3 as the dog. Nevertheless, if the artificial neural network classifies the object in the photo of FIG. 3 as the dog, this may mean that the artificial neural network is overfitted with data similar to FIG. 3.

The processor 110 may compute the confidence level by using the similarity and the relation degree (S500).

According to some exemplary embodiments of the present disclosure, the confidence level may be computed by using at least one of a distribution or variability of the similarity and the relation degree, the relationship between the first data set and the second data set, and the interpretation degree for the artificial neural network.

For example, the processor 110 may increase the confidence level as the distribution and variability (e.g., dispersion) of the similarity and the relation degree are smaller than pre-set criteria. Further, as the similarity between the first data set and the second data set is lower and the interpretation degree is lower, the confidence level may be lowered.

As another example, even when the processor 110 has the same similarity, relation degree, and interpretation degree according to a domain to which the confidence level determination method according to the present disclosure is applied, the processor 110 may provide the confidence level differently.

For example, if the confidence level determination method according to the present disclosure is applied to a financial business, providing an accurate prediction result may be required more than providing sufficient interpretation power, and conversely, if the confidence level determination method according to the present disclosure is applied to a military/security field, it may be required to provide the sufficient interpretation power rather than the accurate prediction result.

Since this is just an example of a method for providing the confidence level, the scope is not limited thereto.

According to the above description, information for comprehensively determining whether there is data to be well inferred on a data distribution (similarity) and whether a network performs inference based on an appropriate feature (relation degree) may be provided to the user as the confidence level.

The processor 110 may perform the update of the confidence level (S600).

Error information according to the present disclosure may mean information obtained by computing and processing the confidence level, the similarity, the relation degree, and the interpretation degree provided by the processor 110 by reflecting the error information to human inspection by an operator using the confidence level determination method according to the present disclosure.

For example, when the operator determines that there is a problem in determining the similarity in a confidence degree determination process, the processor 110 may receive information (error information) that there is a problem in the similarity determination through an input device (not illustrated). In this case, the processor 110 may change an algorithm used for the similarity determination.

When information that there is a problem in determining the relation degree is input, the processor 110 may change a method used for generating the interpretation data or change a derivation method of the correlation.

The processor 110 may perform the update of the confidence level based on the error information and decide the updated confidence level as a final confidence level.

According to the above description, the processor 110 may provide a more accurate confidence level value that reflects domain knowledge, etc., to the user.

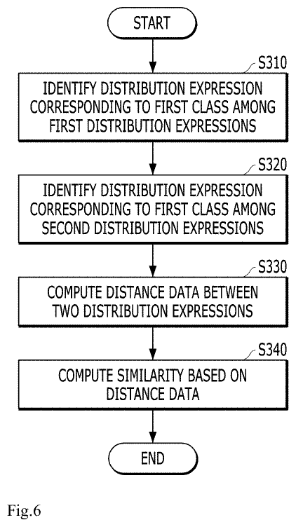

FIG. 6 is a flowchart illustrating an example in which a processor computes a similarity according to the present disclosure.

The processor 110 may identify a distribution expression corresponding to the first class in the first distribution expression (S310).

Data included in a predetermined data set may correspond to one or more classes and respective classes may be expressed by a specific distribution in the latent space. Referring to FIG. 2, a first class 210, a second class 220, and a third class 230 may be expressed by specific distributions, respectively.

The processor 110 may identify a distribution expression corresponding to the first class in the second distribution expression (S320).

When there is a plurality of data corresponding to the same class among the data included in the first data set and the second data set, the distance data between the distributions for each class may be computed and the similarity may be computed.

The processor 110 may compute the distance data between two distribution expressions (S330).

As described above in FIG. 2, in the present disclosure, distance data may be data expressing a distance between distributions of two different classes or two cluster data.

As an example, when the distribution expression is an average value of coordinates of data included in the cluster in the latent space, distance data between two different clusters may be expressed as a Euclidean distance.

As another example, when the distribution expression is the probability distribution of the data in the latent space, the distance data between two different clusters may be computed by using Kullback-Leibler divergence.

This is just an example of a method for computing the distance data between two different clusters and the method for computing the distance data is not limited thereto.

The processor 110 may compute the similarity based on the distance data (S340).

By computing the similarity as described above, a statistical similarity between different data clusters may be determined. For example, a similarity between a data cluster corresponding to the first cluster in the first data set and the data cluster corresponding to the first class in the second data set may be determined by the computation of the similarity (it is assumed that a plurality of data included in the first data set and a plurality of data included in the second data set are expressed in the same latent space).

In particular, referring to FIG. 6, the processor 110 may compare the similarity of the data for each same class. Accordingly, the confidence level may be extracted for each class in the data set to provide more sophisticated determination to the user.

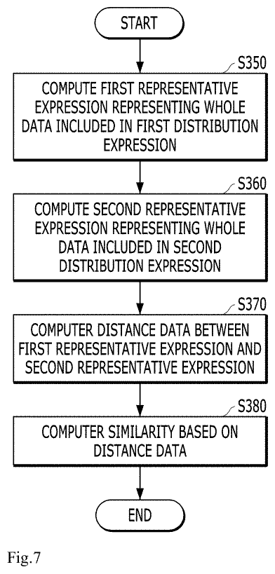

FIG. 7 is a flowchart illustrating an example in which a processor computes a similarity according to the present disclosure.

The processor 110 may compute a first representative expression representing whole data included in the first distribution expression (S350).

The processor 110 may compute a second representative expression representing whole data included in the second distribution expression (S360).

According to some exemplary embodiments of the present disclosure, the whole data may be defined as all data included in a predetermined data set.

Here, the representative expression may be a representative value (parameter) that may represent the statistical characteristics of the whole data. For example, the representative expression for the first data set may be an average of coordinates of data included in the first data set in the latent space. Since this is just an example of the representative expression, the scope is not limited thereto.

The processor 110 may compute the distance data between the first representative expression and the second representative expression (S370).

In the present disclosure, the distance data may be data expressing a distance between distributions of two different classes or cluster data.

As an example, when the distribution expression is an average value of coordinates of data included in the cluster in the latent space, distance data between two different clusters may be expressed as a Euclidean distance.

Accordingly, in some exemplary embodiments of the present disclosure, the distance data between the representative expressions may be expressed as a Euclidean distance between the first representative expression and the second representative expression.

A similarity may be a value representing a statistical origin relationship of data included in two clusters, based on the computed distance data.

The processor 110 may compute the similarity based on the distance data (S380).

When the relationship between the first data set and the second data set is unknown, it may be inefficient to determine the statistical similarity of the distribution for all classes. Therefore, in this case, if the characteristics of the whole data may be compared first, the amount of computation required to determine the similarity and confidence level may be reduced.

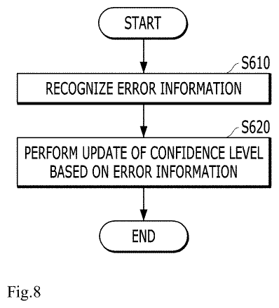

FIG. 8 is a flowchart illustrating an example in which a processor performs an update of a confidence level according to the present disclosure.

The processor 110 may recognize error information based on at least one of the similarity, the relation degree, or the interpretation degree (S610).

Error information according to the present disclosure may mean information obtained by computing and processing the confidence level, the similarity, the relation degree, and the interpretation degree provided by the processor 110 by reflecting the error information to human inspection by an operator using the confidence level determination method according to the present disclosure.

The processor 110 may perform an update of the confidence level based on the error information (S620).

For example, when the operator determines that there is a problem in determining the similarity in a confidence degree determination process, the processor 110 may receive information (error information) that there is the problem in the similarity determination through an input device (not illustrated). In this case, the processor 110 may change an algorithm used for the similarity determination.

When information that there is a problem in determining the relation degree is input, the processor 110 may change a method used for generating the interpretation data or change a derivation method of the correlation.

The processor 110 may perform the update of the confidence level based on the error information and decide the updated confidence level as a final confidence level.

According to the above description, the processor 110 may provide a more accurate confidence level value that reflects domain knowledge, etc., to the user.

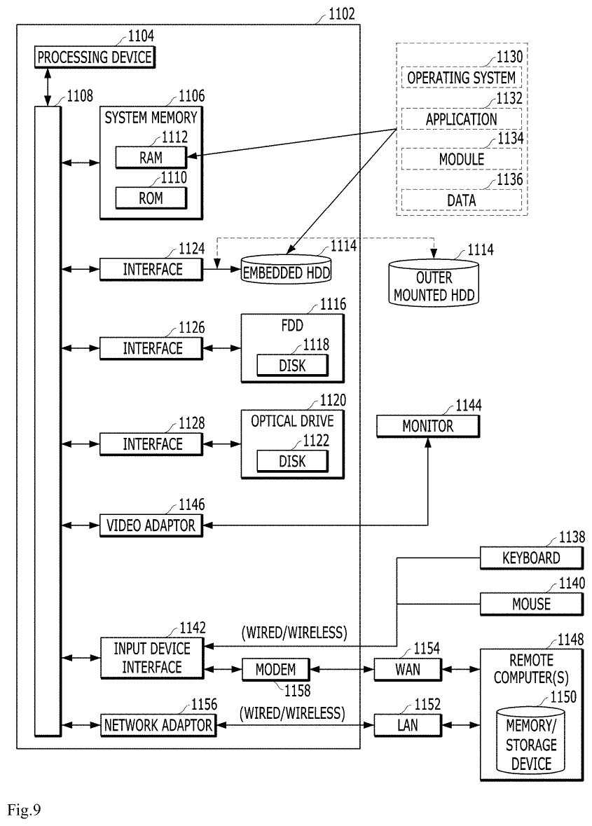

FIG. 9 illustrates a simple and general schematic view of an exemplary computing environment in which some exemplary embodiments of the present disclosure may be implemented.

In a computer 1102 illustrated in FIG. 9 may correspond to at least one of computer devices 100 performing the confidence level determination method according to the present disclosure.

The present disclosure has generally been described above in association with a computer executable command which may be executed on one or more computers, but it will be well appreciated by those skilled in the art that the present disclosure may be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by configuring or changing at least one of characteristics of the signal to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor 110 among various commercial processors 110. A dual processor 110 and other multi-processor (110) architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems that are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for a brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150.

It will be well known that an illustrated network connection is exemplary and other means configuring a communication link among computers may be used.

The computer 1102 performs an operation of communicating with predetermined wireless devices or entities which are disposed and operated by wireless communication, for example, the printer, a scanner, a desktop and/or a portable computer, a portable data assistant (PDA), a communication satellite, predetermined equipment or place associated with a wirelessly detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) to provide safe, reliable, and high-speed wireless connection. The Wi-Fi may be used to connect the computers or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors 110, means, circuits, and algorithm steps described in association with the exemplary embodiments disclosed herein may be implemented by electronic hardware, various types of programs or design codes (for easy description, herein, designated as “software”), or a combination of all of them. To clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, an apparatus, or a standard programming and/or engineering technique. The term “manufactured article” includes a computer program, a carrier, or a medium which is accessible by a predetermined computer readable device. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

It will be appreciated that a specific order or a hierarchical structure of steps in the presented processes is one example of exemplary access. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be analyzed within the widest range which is coherent with the principles and new features presented herein.

What is claimed is:

1. A non-transitory computer readable medium storing a computer program, wherein the computer program comprising instructions for causing one or more processors to perform the following steps, the steps comprising:
obtaining a first distribution expression, wherein the first distribution expression is an expression of a distribution in a latent space for at least one class included in a first class set related to a first data set;
obtaining a second distribution expression, wherein the second distribution expression is an expression of a distribution in a latent space for each of the at least one class included in a second class set related to a second data set;
computing a similarity between the first distribution expression and the second distribution expression;
computing a relation degree between an interpretation degree and an inference result for the second data set, based on an interpretation data about an artificial neural network; and
computing a confidence level using the similarity and the relation degree.

2. The non-transitory computer readable medium according to claim 1,
wherein the first data set is a training data set and wherein the second data set is a validation data set.

3. The non-transitory computer readable medium according to claim 1, wherein the obtaining a second distribution expression comprises:
feeding the second data set to the artificial neural network repeatedly until the second distribution expression meets a pre-set criteria.

4. The non-transitory computer readable medium according to claim 1,
wherein the computing a similarity between the first distribution expression and the second distribution expression comprises:
computing a similarity based on distance data between the first distribution expression and the second distribution expression, wherein the distance data is computed based on the class related to the first data and the second data.

5. The non-transitory computer readable medium according to claim 4, wherein the computing a similarity based on distance data between the first distribution expression and the second distribution expression comprises:
identifying a distribution expression corresponding to the first class in the first distribution expression;
identifying a distribution expression corresponding to the first class in the second distribution expression;
computing the distance data between two said distribution expression corresponding to the first class; and
computing the similarity based on the distance data.

6. The non-transitory computer readable medium according to claim 1,
wherein the computing a similarity between the first distribution expression and the second distribution expression comprises:
computing a similarity based on each representative expression of the first distribution expression and the second distribution expression.

7. The non-transitory computer readable medium according to claim 6, wherein the computing a similarity based on each representative expression of the first distribution expression and the second distribution expression comprises:
computing a first representative expression represents whole data included in the first distribution expression;
computing a second representative expression represents whole data included in the second distribution expression;
computing a distance data between the first representative expression and the second representative expression; and
computing the similarity based on the distance data.

8. The non-transitory computer readable medium according to claim 1, wherein the confidence level is computed using at least one among a distribution or variance of the similarity and the relation degree, a relationship between the first data set and the second data set, or the interpretation degree of the artificial neural network.

9. The non-transitory computer readable medium according to claim 1, wherein the steps further comprise:
recognizing error information based on at least one of the similarity, the relation degree or the interpretation degree; and
performing the confidence level update based on the error information.
